(19) United States
(12) Patent Application Publication
(10) Pub. No.: US 2017/0323616 A1
(43) Pub. Date: Nov. 9, 2017

(54) IMAGE DEVICE WITH IMPROVED CHROMINANCE QUALITY

(71) Applicant: VP ASSETS LIMITED, Road Town (VG)

(72) Inventors: GIA-CHUONG PHAN, Berlin (DE); MAGGIE PHAN, Vancouver (CA); ANTHONY PHAN, Vancouver (CA); SHI-KI DONG, Shatin (HK); HON-WAH WONG, Shatin (HK); KA-HO NG, Shatin (HK)

(21) Appl. No.: 15/149,168

(22) Filed: May 8, 2016

(51) Int. Cl. G09G 5/02

(52) U.S. Cl. CPC G09G 5/02; G09G 2320/02

(57) ABSTRACT

An image device includes a plurality of first sub-pixels, a plurality of second sub-pixels, a plurality of third sub-pixels, a plurality of fourth sub-pixels, and a plurality of fifth sub-pixels. The image device further is consisted by a plurality of basic repeating units in a 2×8 matrix. Each of the basic repeating units comprises the first sub-pixels, the second sub-pixels, the third sub-pixels, the fourth sub-pixels, and the fifth sub-pixel. A ratio of the first sub-pixels to the second sub-pixels to the third sub-pixels to the fourth sub-pixels and to the fifth sub-pixel in the basic repeating unit is 4:4:4:3:1.

### FIELD

The subject matter herein generally relates to display technology, pertains particularly to image device with improved chrominance quality of an image device or a display by the utilization of RGBW pixels and RGBY pixels.

### TECHNICAL FIELD

Referring to FIG. 1, it shows a conventional RGBW display. The conventional RGBW display 10 includes a plurality of RGBW pixels 11. Each RGBW pixel 11 includes a green sub-pixel 111, a red sub-pixel 112, a blue sub-pixel 113 and a white sub-pixel 114 arranged in a 2×2 matrix. The conventional RGBW display 10 has the merit of enhanced color space and improved brightness and contrast, compared with traditional RGB display. U.S. Pat. No. 4,892,391, U.S. Pat. No. 5,757,452, U.S. Pat. Nos. 7,286,136, 7,742,205, and U.S. Pat. No. 7,583,279 teach RGBW displays. However, the conventional RGBW display 10 has the deficiency of dark yellow. U.S. Pat. No. 4,800,375, U.S. Pat. No. 7,864,271, and U.S. Pat. No. 8,749,727 teach RGBY displays which claim to have better yellow color. However, RGBY display lacks the merits of RGBW displays. U.S. Pat. No. 7,248,314, U.S. Pat. No. 7,995,019, U.S. Pat. No. 8,248,440, U.S. Pat. No. 8,441,601 and U.S. Pat. No. 8,558,857 teach displays with five color sub-pixels. However five color displays have the deficiency of high cost and low brightness and contrast. U.S. Pat. No. 8,384,653 teaches a method to relief the dark yellow problem by classifying the image signal and then adjusts the backlight luminance according to the classification.

### BRIEF DESCRIPTION OF THE DRAWINGS

Implementations of the present technology will now be described, by way of example only, with reference to the attached figures.

FIG. 1 illustrates a conventional RGBW display.

FIG. 2 illustrates an image device according to a first embodiment of the present disclosure.

FIG. 3 illustrates an example of the image device of FIG. 2 according to the first embodiment of the present disclosure.

FIGS. 4-9 illustrate image devices according to an embodiment of the present disclosure.

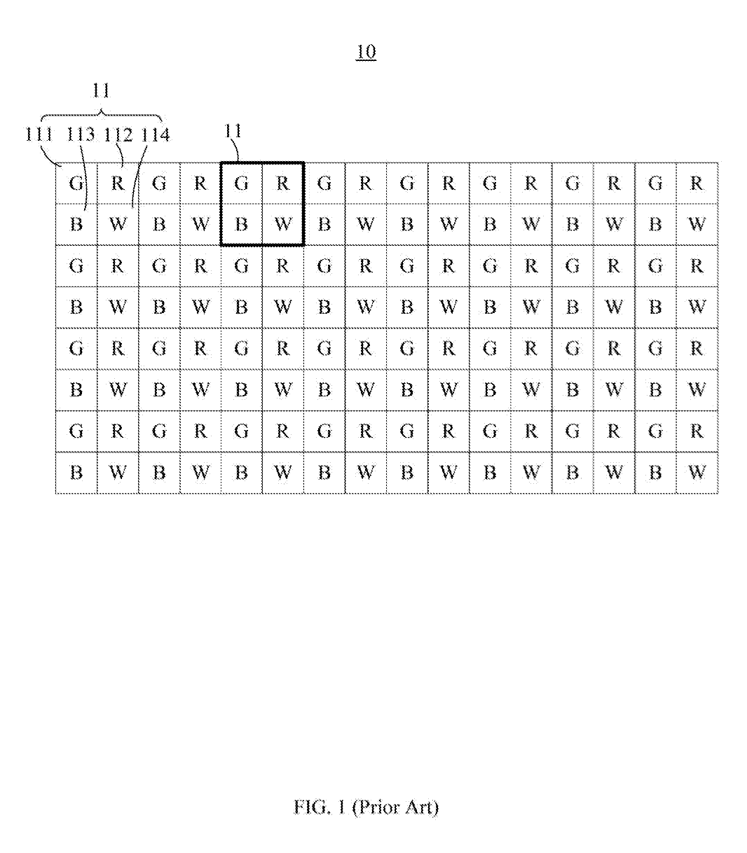

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features. The description is not to be considered as limiting the scope of the embodiments described herein.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

For consistency purpose and ease of understanding, like features are identified (although, in some instances, not shown) with like numerals in the exemplary figures. However, the features in different embodiments may differ in other respects, and thus shall not be narrowly confined to what is shown in the figures.

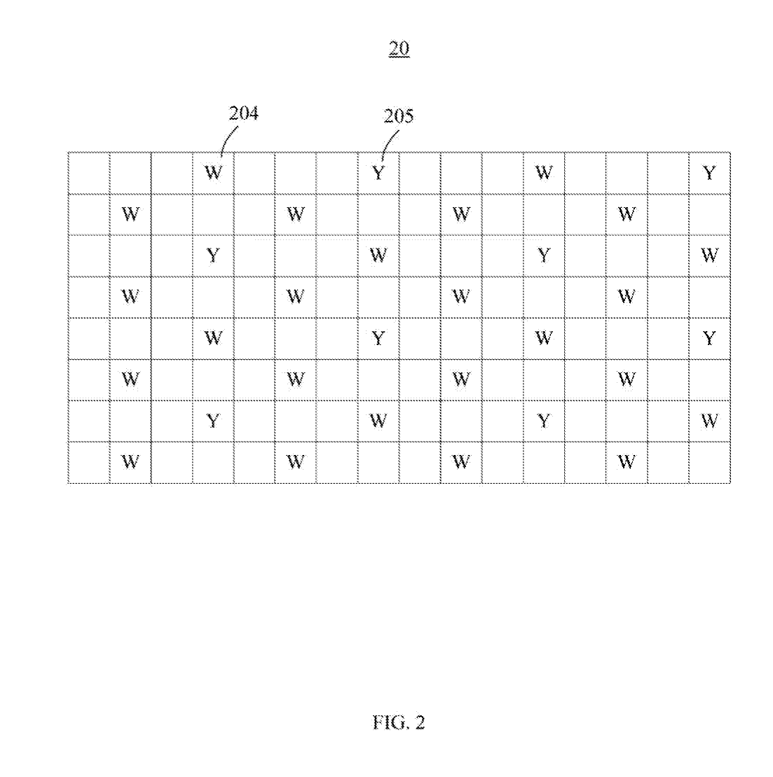

FIG. 2 illustrates a schematic planar of an image device 20 in accordance with some embodiments of the instant disclosure. The image device 20 includes a plurality of pixels including a plurality of sub-pixels with different colors arranged in a matrix of rows and columns. As shown in FIG. 2, the image device 20 includes a plurality of white sub-pixels 204 and a plurality of yellow sub-pixels 205. Every odd row includes white sub-pixels 204 and yellow sub-pixels 205. Every even row includes the white sub-pixels 204 without the yellow sub-pixel 205. Namely, in any two adjacent rows, one of the two adjacent rows contains the white sub-pixels 204 and the yellow sub-pixels 205, and the other of the two adjacent rows merely contains the white sub-pixels 204. The white sub-pixels 204 and the yellow sub-pixels 205 in the same row are staggered disposed, and the white sub-pixels 204 and the yellow sub-pixels 205 in the same column are staggered disposed. In each row containing the white sub-pixels 204 and the yellow sub-pixels 205, each of the yellow sub-pixels 205 is arranged between two adjacent white sub-pixels 204, and each yellow sub-pixel 205 and the adjacent white sub-pixel 204 are separated by three sub-pixels different from the white sub-pixel 204 and the yellow sub-pixel 205. In each row containing the white sub-pixels 204 and excluding the yellow sub-pixels 205, two adjacent white sub-pixels 204 are separated by three sub-pixels different from the white sub-pixel 204 and the yellow sub-pixel 205. Every even column includes at least one white sub-pixels 204. Namely, in any two adjacent even columns, one of the two adjacent even columns includes the white sub-pixels 204, and the adjacent even column includes white sub-pixels 204 and the yellow sub-pixels 205. In each column containing the white sub-pixels 204 and the yellow sub-pixels 205, each white sub-pixel 204 and the adjacent yellow sub-pixel 205 are separated by one sub-pixel different from the white sub-pixel 204 and the yellow sub-pixel 205. In each column containing the white sub-pixels 204 and excluding the yellow sub-pixel 205, two adjacent white sub-pixels 204 are separated by one sub-pixel different from the white sub-pixel 204 and the yellow sub-pixel 205. FIG. 2 shows an arrangement rule of the sub-pixels.

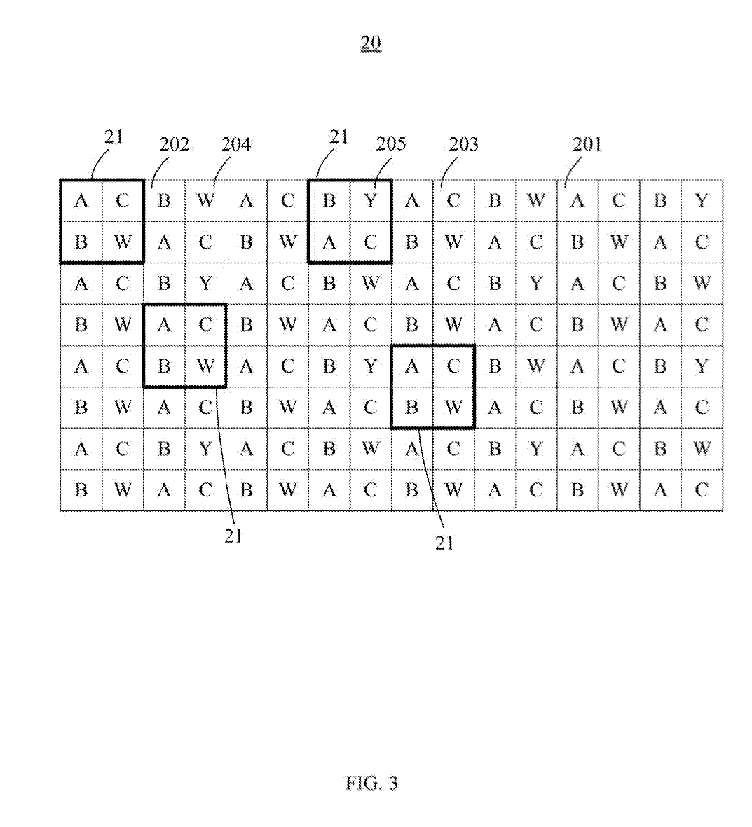

FIG. 3 illustrates an example of the image device 20 of FIG. 2 according the embodiment of the present disclosure. The image device 20 includes a plurality of pixels including a plurality of sub-pixels with different colors arranged in a matrix of rows and columns. As shown in FIG. 3, the image device 20 includes a plurality of A sub-pixels 201, a plurality of B sub-pixels 202, a plurality of C sub-pixels 203, a plurality of white sub-pixels 204 and a plurality of yellow sub-pixels 205. In any 2×2 matrix 21, there are always one A sub-pixel 201, one B sub-pixel 202, and one C sub-pixel 203. In other words, the image device 20 may include a plurality of ABCW pixels and a plurality of ABCY pixels. Each ABCW pixel includes one A sub-pixel 201, one B sub-pixel 202, one C sub-pixel 203 and one white sub-pixel 204. Each ABCY pixel includes one A sub-pixel 201, one B sub-pixel 202, one C sub-pixel 203 and one yellow sub-pixel 205. The ABCW pixels and the ABCY pixels are mixed in the image device 20. The A sub-pixel 201, the B sub-pixel 202, and the C sub-pixel 203 may respectively be a red sub-pixel, a green sub-pixel, or a blue sub-pixel, as required or designed. Namely, the A sub-pixel 201 may be a red sub-pixel, a green sub-pixel, or a blue sub-pixel, the B sub-pixel 202 may be a red sub-pixel, a green sub-pixel, or a blue sub-pixel, and the C sub-pixel 203 may be a red sub-pixel, a green sub-pixel, or a blue sub-pixel.

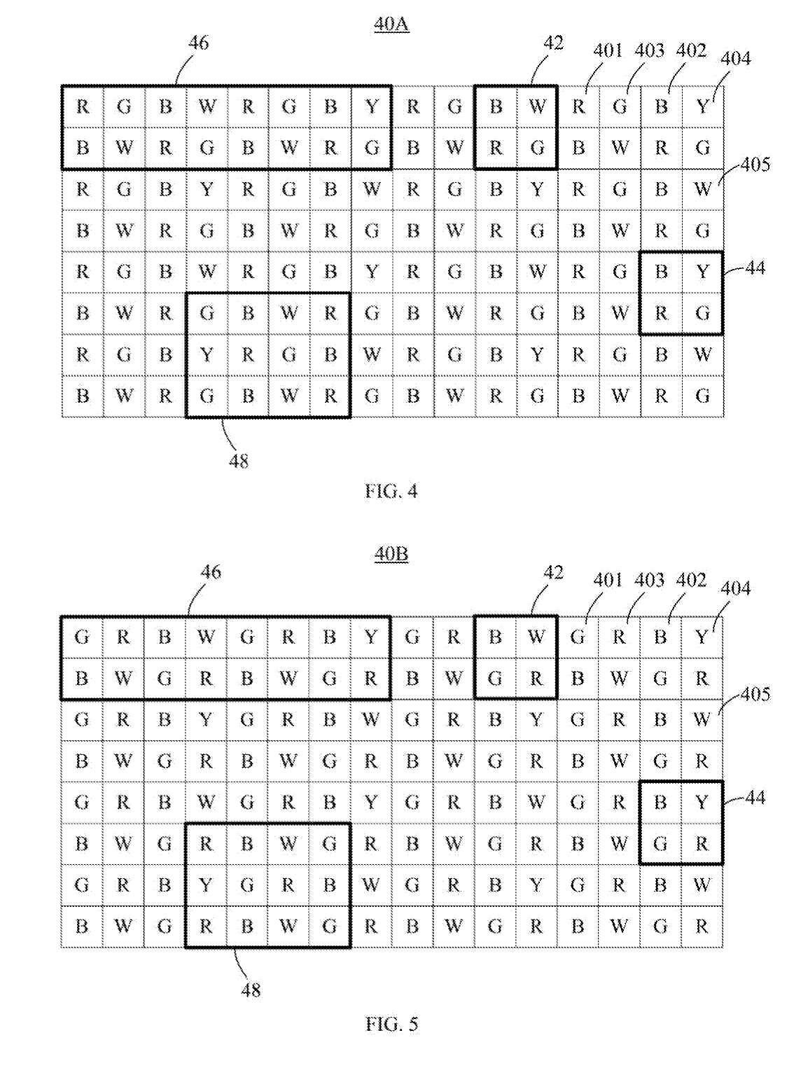

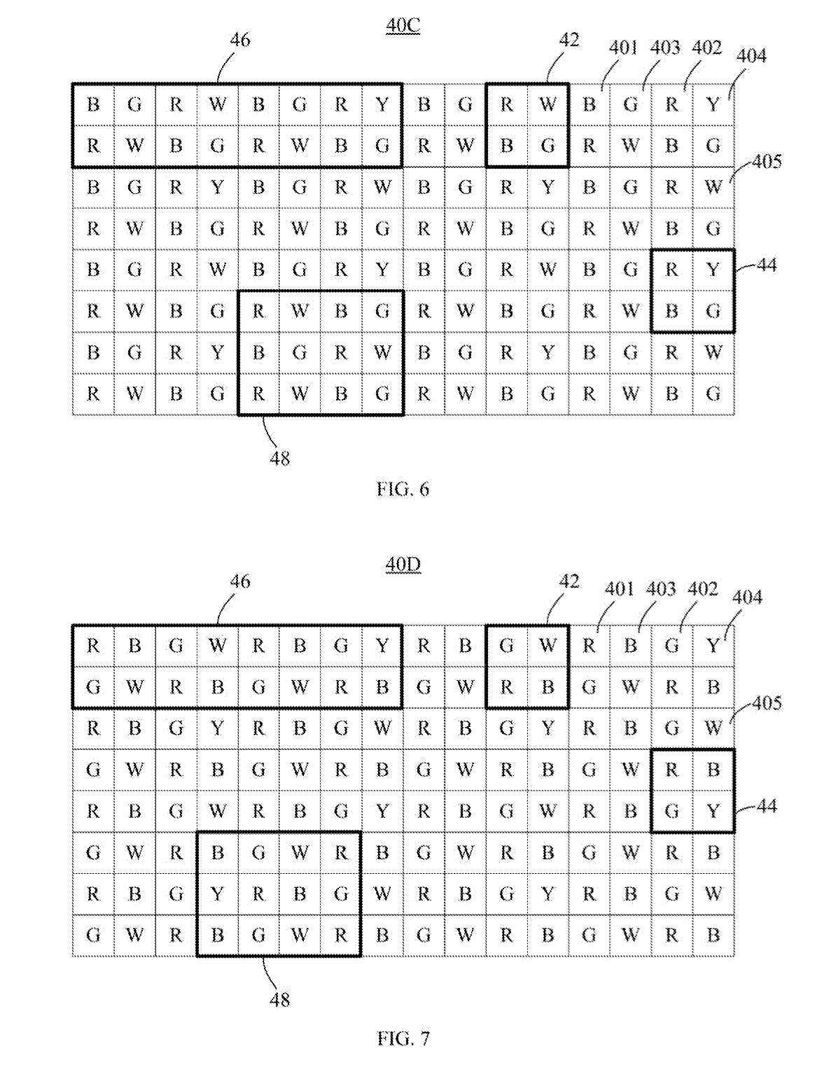

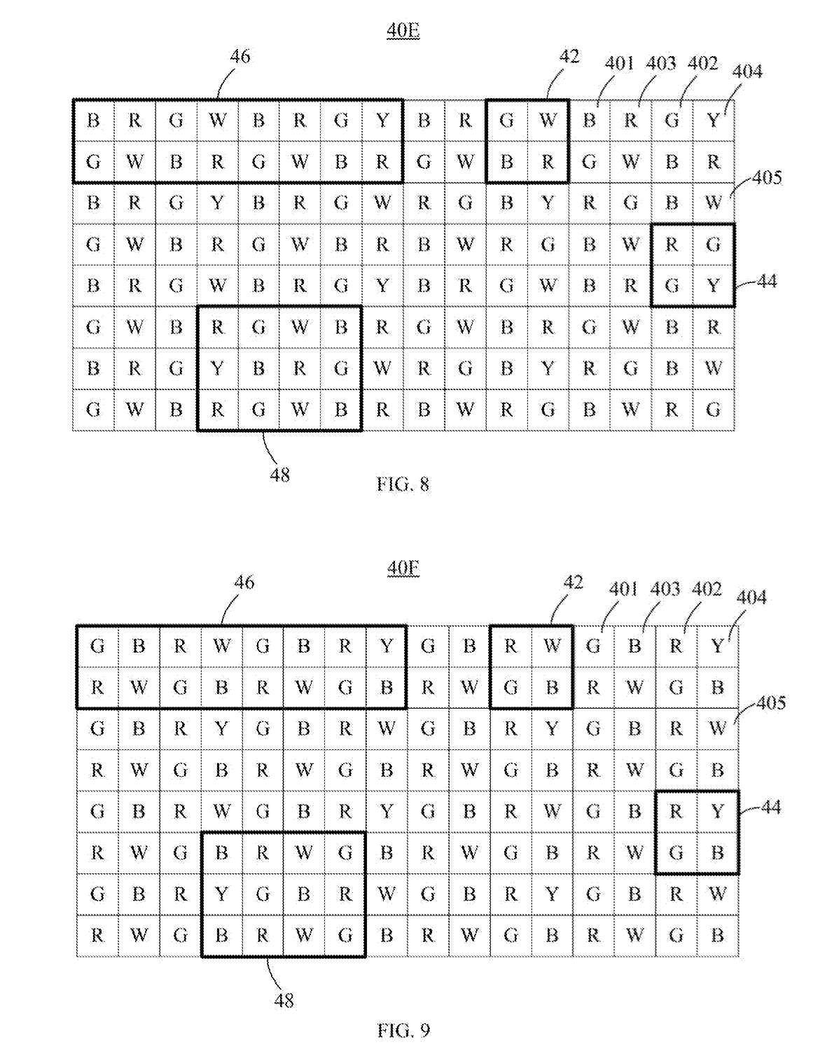

FIGS. 4-9 illustrate several modified examples of image devices 40A-40F following the arrangement rule of the white sub-pixels and yellow sub-pixel described above shown in FIG. 2 according to an embodiment of the present disclosure. Each of the image devices 40A-40F includes a plurality of pixels including a plurality of sub-pixels with different colors arranged in a matrix of rows and columns. More specifically, each of the image devices 40A-40F includes a plurality of RGBW pixels 42 and a plurality of RGBY pixels 44. Each RGBW pixels 42 includes one red sub-pixel 401, one green sub-pixel 402, one blue sub-pixel 403 and one white sub-pixel 404. Each RGBY pixel includes one red sub-pixel 401, one green sub-pixel 402, one blue sub-pixel 403 and one yellow sub-pixel 405. The RGBW pixels 42 and the RGBY pixels 44 are mixed in each of the image devices 40A-40F.

As shown in FIGS. 4-9, each of the image devices 40A-40F includes a plurality of white sub-pixels 404 and a plurality of yellow sub-pixels 405. Every odd row includes white sub-pixels 404 and yellow sub-pixels 405. Every odd row includes white sub-pixels 404 and yellow sub-pixels 405. Every even row includes the white sub-pixels 404 and excludes the yellow sub-pixel 405. Namely, in any two adjacent rows, one of the two adjacent rows contains the white sub-pixels 404 and the yellow sub-pixels 405, and the other of the two adjacent rows contains the white sub-pixels 404 and excludes the yellow sub-pixel 205. The white sub-pixels 404 and the yellow sub-pixels 405 in the same row are staggered disposed, and the white sub-pixels 404 and the yellow sub-pixels 405 in the same column are staggered disposed. In each row containing the white sub-pixels 404 and the yellow sub-pixels 405, each of the yellow sub-pixels 405 is arranged between two adjacent white sub-pixels 404, and each yellow sub-pixel 405 and the adjacent white sub-pixel 404 are separated by three sub-pixels different from the white sub-pixel 404 and the yellow sub-pixel 405. In each row containing the white sub-pixels 404 and excluding the yellow sub-pixels 405, two adjacent white sub-pixels 404 are separated by three sub-pixels different from the white sub-pixel 404 and the yellow sub-pixel 405. Every even column includes at least one white sub-pixels 404. Namely, in any two adjacent even columns, one of the two adjacent even columns includes the white sub-pixels 404, and the adjacent even column includes white sub-pixels 404 and the yellow sub-pixels 405. In each column containing the white sub-pixels 404 and the yellow sub-pixels 405, each white sub-pixel 404 and the adjacent yellow sub-pixel 405 are separated by one sub-pixel different from the white sub-pixel 404 and the yellow sub-pixel 405. In each column containing the white sub-pixels 404 and excluding the yellow sub-pixel 405, two adjacent white sub-pixels 404 are separated by one sub-pixel different from the white sub-pixel 404 and the yellow sub-pixel 405.

As shown in FIGS. 4-9, a basic repeating unit 46 is defined. The basic repeating unit 46 is a 2×8 matrix with different color sub-pixels. Repeating the basic repeating unit 46 as much as required to form each of the image devices 40A-40F. In the basic repeating unit 46, a ratio of the number of the red sub-pixels 401 to the number of the green sub-pixels 402 to the number of the blue sub-pixels 403 to the number of the white sub-pixels 404 and to the number of the yellow sub-pixels 405 is about 4:4:4:4:3:1. Furthermore, in the basic repeating unit 46, a ratio of the total area of red sub-pixels 401 to the total area of green sub-pixels 402 to the total area of blue sub-pixels 403 to the total area of white sub-pixels 404 and to the total area of yellow sub-pixels 405 is about 4:4:4:3:1.

As shown in FIGS. 4-9, a 3×4 matrix 48 is defined. In the 3×4 matrix 48, a ratio of the number of the red sub-pixels 401 to the number of the green sub-pixels 402 to the number of the blue sub-pixels 403 to the number of the white sub-pixels 404 and to the number of the yellow sub-pixels 405 is about 3:3:3:2:1. Furthermore, in the 3×4 matrix 48, a ratio of the total area of red sub-pixels 401 to the total area of green sub-pixels 402 to the total area of blue sub-pixels 403 to the total area of white sub-pixels 404 and to the total area of yellow sub-pixels 405 is about 3:3:3:2:1.

More specifically, when chooses any 3×4 matrix in each of the image devices 40A-40F, a ratio of the number of the red sub-pixels 401 to the number of the green sub-pixels 402 to the number of the blue sub-pixels 403 to the number of the white sub-pixels 404 and to the number of the yellow sub-pixels 405 is about 3:3:3:2:1. When chooses any 3×4 matrix in each of the image devices 40A-40F, a ratio of the total area of the red sub-pixels 401 to the total area of the green sub-pixels 402 to the total area of the blue sub-pixels 403 to the total area of the white sub-pixels 404 and to the total area of the yellow sub-pixels 405 is about 3:3:3:2:1.

Further, a designated white balance status can be maintained by adjusting the blue information of the image device. In case of liquid-crystal display LCD, for example the backlight color can be adjusted, and/or the thickness, area, and/or pigment of the blue sub-pixels in the color filter can be adjusted, and/or the utilization of quantum dots can be adjusted so as to adjust the blue information and to maintain a designated white balance status of the image device. In case of organic light-emitting diode OLED plus color filter, OLED color can be adjusted to bluish, and/or the thickness, area, and/or pigment of the blue sub-pixels in the color filter can be adjusted, and/or the utilization of quantum dots can be adjusted so as to adjust the blue information and to maintain a designated white balance status of the image device.

The present disclosure also provides a method to determine the ratio of the number of RGBW pixels to the number of RGBY pixels in an image device according to the invention. The method of the present disclosure includes a step for determining the ratio by a function of a yellow sub-pixel information, a red sub-pixel information, a green sub-pixel information, a blue sub-pixel information and a white sub-pixel information of the image device. The sub-pixel information includes the chrominance data and luminance data of the said sub-pixel. In an embodiment, the yellow sub-pixel information includes the chrominance data and luminance data of the yellow sub-pixel, the red sub-pixel information includes the chrominance data and luminance data of the red sub-pixel, the green sub-pixel information includes the chrominance data and luminance data of the green sub-pixel, and the white sub-pixel information includes the chrominance data and luminance data of the white sub-pixel.

By the addition of RGBY pixels, the problem of dark yellow in the conventional RGBW display can be solved and chrominance quality can be improved. The present invention thus can solve the dark yellow problem of conventional RGBW display. The bluish problem can also be solved by the addition of RGBY pixels.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An image device comprising:
a plurality of first sub-pixels;
a plurality of second sub-pixels;
a plurality of third sub-pixels;
a plurality of fourth sub-pixels; and
a plurality of fifth sub-pixels;
wherein the image device further is consisted by a plurality of basic repeating units in a 2×8 matrix; each of the basic repeating units comprises the first sub-pixels, the second sub-pixels, the third sub-pixels, the fourth sub-pixels, and the fifth sub-pixel; a ratio of the first sub-pixels to the second sub-pixels to the third sub-pixels, the fourth sub-pixels to the fifth sub-pixel in the basic repeating unit is 4:4:4:3:1.

2. The image device of claim 1, wherein a ratio of first sub-pixels, the second sub-pixels, the third sub-pixels, the fourth sub-pixels, and the fifth sub-pixel in a stochastic 3×4 matrix is 3:3:3:2:1.

3. The image device of claim 1, wherein there are first sub-pixel, the second sub-pixel, the third sub-pixel in any 2×2 matrix; a combination of the 2×2 matrix is consisted by the first sub-pixel, the second sub-pixel, the third sub-pixel, and the fourth sub-pixel; another combination of the 2×2 matrix is consisted by the first sub-pixel, the second sub-pixel, the third sub-pixel, and the fifth sub-pixel.

4. The image device of claim 1, wherein odd rows of the image device comprise the fourth sub-pixels and the fifth sub-pixels, and even rows of the image device merely comprise the fourth sub-pixels and exclude the fifth sub-pixel.

5. The image device of claim 4, wherein the fourth sub-pixels and the fifth sub-pixels in the same row are staggered disposed, and the fourth sub-pixels and the fifth sub-pixels in the same column are staggered disposed.

6. The image device of claim 4, wherein in each row containing fourth sub-pixels and the fifth sub-pixels, each of the fifth sub-pixels is arranged between two adjacent fourth sub-pixels, and each of fourth sub-pixels and the adjacent fifth sub-pixel are separated by three sub-pixels different from the fourth sub-pixel and the fifth sub-pixel.

7. The image device of claim 4, wherein in each row containing fourth sub-pixels and excluding the fifth sub-pixel, and two adjacent fifth sub-pixels are separated by three sub-pixels different from the fourth sub-pixel and the fifth sub-pixel.

8. The image device of claim 1, wherein one even column of any two adjacent even columns comprises the fourth sub-pixel without fifth sub-pixels, and the adjacent even column of any two adjacent even columns comprises fourth sub-pixels and the fifth sub-pixels.

9. The image device of claim 8, wherein in each column containing the fourth sub-pixel and the yellow sub-pixels, the fourth sub-pixel and the adjacent yellow sub-pixels are separated by one sub-pixel different from the fourth sub-pixel and the yellow sub-pixel.

10. The image device of claim 8, wherein in each column containing the fourth sub-pixel and excluding the yellow sub-pixels, two adjacent fourth sub-pixels are separated by one sub-pixel different from the fourth sub-pixel and the yellow sub-pixel.

11. An image device comprising:
a plurality of first sub-pixels;
a plurality of second sub-pixels;
a plurality of third sub-pixels;
a plurality of fourth sub-pixels; and
a plurality of fifth sub-pixels;
wherein there are first sub-pixel, the second sub-pixel, the third sub-pixel in any 2×2 matrix; a combination of the 2×2 matrix is consisted by the first sub-pixel, the second sub-pixel, the third sub-pixel, and the fourth sub-pixel; another combination of the 2×2 matrix is consisted by the first sub-pixel, the second sub-pixel, the third sub-pixel, and the fifth sub-pixel; odd rows of the image device comprise the fourth sub-pixels and the fifth sub-pixels simultaneously, and even rows of the image device merely comprise the fourth sub-pixels and exclude the fifth sub-pixel.

12. The image device of claim 11, wherein the image device further is consisted by a plurality of a basic repeating units in a 2×8 matrix; each of the basic repeating units comprises the first sub-pixels, the second sub-pixels, the third sub-pixels, the fourth sub-pixels, and the fifth sub-pixel.

13. The image device of claim 12, wherein a ratio of the first sub-pixels, the second sub-pixels, the third sub-pixels, the fourth sub-pixels, and the fifth sub-pixel in the basic repeating unit is 4:4:4:3:1.

14. The image device of claim 12, wherein a ratio of first sub-pixels, the second sub-pixels, the third sub-pixels to the fourth sub-pixels to the fifth sub-pixel in a stochastic 3×4 matrix is 3:3:3:2:1.

15. The image device of claim 11, wherein the fourth sub-pixels and the fifth sub-pixels in the same row are staggered disposed, and the fourth sub-pixels and the fifth sub-pixels in the same column are staggered disposed.

16. The image device of claim 11, wherein in each row containing fourth sub-pixels and the fifth sub-pixels, each of the fifth sub-pixels is arranged between two adjacent fourth sub-pixels, and each of fourth sub-pixels and the adjacent fifth sub-pixel are separated by three sub-pixels different from the fourth sub-pixel and the fifth sub-pixel.

17. The image device of claim 11, wherein in each row containing fourth sub-pixels and excluding the fifth sub-pixel, and two adjacent fifth sub-pixels are separated by three sub-pixels different from the fourth sub-pixel and the fifth sub-pixel.

18. The image device of claim 11, wherein one even column of any two adjacent even columns comprises the fourth sub-pixel without fifth sub-pixels, and the adjacent even column of any two adjacent even columns comprises fourth sub-pixels and the fifth sub-pixels.

19. The image device of claim 11, wherein in each column containing the fourth sub-pixel and the yellow sub-pixels, the fourth sub-pixel and the adjacent yellow sub-pixels are separated by one sub-pixel different from the fourth sub-pixel and the yellow sub-pixel.

20. The image device of claim 11, wherein in each column containing the fourth sub-pixel and excluding the yellow sub-pixels, two adjacent fourth sub-pixels are separated by one sub-pixel different from the fourth sub-pixel and the yellow sub-pixel.
